(19) United States
(12) Patent Application Publication
(10) Pub. No.: US 2008/0183535 A1
(43) Pub. Date: Jul. 31, 2008

(54) Method and system for inspecting rental vehicles

(76) Inventor: Mordechai Kahana, Whippany, NJ (US)

Correspondence Address: Alexander Ching, 206 West Snyder, Hobbs, NM, 88240, US

(21) Appl. No.: 12/080,064

(22) Filed: Mar. 29, 2008

Related U.S. Application Data
(63) Continuation-in-part of application No. 09/885,495, filed on Jun. 20, 2001.
(60) Provisional application No. 60/921,394, filed on Mar. 30, 2007.

(51) Int. Cl. G06Q 10/00; H04N 5/222

(52) U.S. Cl. 705/7; 348/722; 348/E05.024

(57) ABSTRACT

A system for inspecting rental vehicles includes an image capture booth coupled to a rental car computer. In one embodiment, the image capture booth includes a first camera mounted on a first tower, a second camera mounted on a second tower, and a path defined between the first tower and the second tower for the rental vehicle to pass through. When a rental vehicle travels down the path, the first camera and the second camera configured to capture images of the rental vehicle as it drives down the path. The rental car computer is configured to receive the images of the rental vehicle.

This patent application is a continuation in part of patent application Ser. No. 09/885,495, and claims priority to provisional patent application 60/921,394 filed Mar. 29, 2007.

### FIELD OF THE INVENTION

The present invention generally relates to the field of automobile fleet management and more specifically to a method and system for inspecting rental vehicles.

### BACKGROUND OF THE INVENTION

Although various technical advances have been made in the rental car business, one low tech aspect still remains; damage to rental vehicles is still noted typically on paper forms by rental agents when a vehicle is rented and then returned from renting. Typically, when renting a vehicle, a rental agent uses a preprinted form that has a picture of a car on it. The agent makes notations on the picture of the vehicle, noting the approximate locations of scratches, dents and the like. Problems with this method of denoting damage include that only the approximate location of damage can be noted and not the actual characteristics (such as size of dent or length/depth of scratch) of the damage. This can lead to disputes between customers and rental agents. Also, paper forms are easily lost. Additionally, because of the inconvenience of the paper form, at times the inspections are not done. When this occurs, the potential for missing damage caused by renters increases, which can increase the cost to the rental agency.

Accordingly, it is desirable to provide a method and system for inspecting rental vehicles. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

In one embodiment of the present invention a system for inspecting rental vehicles comprises an image capture booth coupled to a rental car computer. The image capture booth is configured to capture images of the rental vehicle. The images include an indication of damage to the rental vehicle. The rental computer is configured to receive the images of the rental vehicle.

In an alternative embodiment of the present invention a method for tracking damages to a rental vehicle comprises a first step of capturing images of the rental vehicle at an image booth. Next, the identification of the rental vehicle is determined. Then, captured images and the identification of the vehicle are sent to a rental car computer system.

In another embodiment, the image capture booth includes a first camera mounted on a first tower, a second camera mounted on a second tower, and a path defined between the first tower and the second tower for the rental vehicle to pass through. When a rental vehicle travels down the path, the first camera and the second camera configured to capture images of the rental vehicle as it drives down the path.

### BRIEF DESCRIPTION OF THE DRAWINGS

The present invention will hereinafter be described in conjunction with the following drawing figures, wherein like numerals denote like elements, and:

FIG. 1 illustrates a system for tracking damages to a rental vehicle in accordance with the teachings of the present invention;

FIG. 2 is a flowchart of an exemplary method for tracking damages to a rental vehicle in accordance with the teachings of the present invention; and

FIG. 3 is a flowchart of an alternative embodiment of the invention to provide data to an automobile remarketer in accordance with the teachings of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

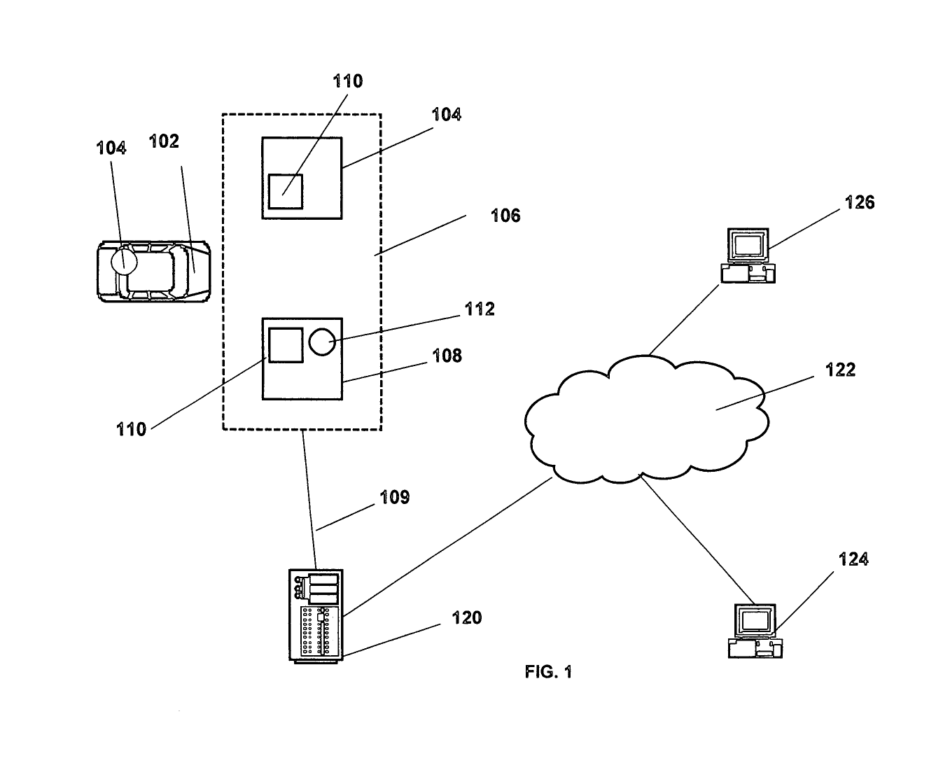

FIG. 1 illustrates an exemplary system 100 in accordance with the teachings of the present invention. System 100 includes an image capture booth 106 coupled to a rental car computer 120. The rental car computer 120 can couple to other computers via a network 122, such as the Internet. In one embodiment, the rental car computer 120 couples to a remarketer computer 124. One or more purchaser computers 126 can couple to the remarketer computer 124 via the network 122.

Image capture booth 106 can be any structure through which a car can be driven or placed within and images of the vehicle, such as photographic images, can be captured. In one exemplary embodiment, image capture booth 106 captures multiple images of vehicle 102 when it is driven through the image capture booth 106. The image capture booth 106, in one embodiment, comprises two towers 108 each having at least one digital camera 110 mounted thereon for capturing images of the vehicle 102 as the vehicle 102 is driven through the image capture booth 106. Towers 108 can be any structure upon which cameras 110 or other electronic devices can be mounted and which vehicle 102 can be driven by. For example, towers 108 can be the walls or roof of a structure, a stand alone structure and the like. While two towers 108 are illustrated, other numbers of towers can be used. In an alternative embodiment a vehicle 102 can remain stationary and the digital camera 110 moves around the vehicle 102.

In an exemplary embodiment of the present invention, cameras 110 are digital cameras having sufficient resolution to resolve scratches, dents, and other types of damages on the vehicle 102's surface. Towers 108 also include any other electronic devices needed to assist the cameras 110 in taking pictures of the vehicle such as flash units or other lighting units. In one exemplary embodiment a total of three cameras are deployed on towers 108 on either side of where vehicle 102 would be driven. As vehicle 102 is driven between the towers one camera 110 on either side of the vehicles would take the front door and passenger side. A second camera 110 on each tower 108 can then take images of the side of the vehicle while a third camera 110 on each tower 108 take images of the back of the vehicle. In an alternative embodiment, camera 110 can take video images as well as still images.

Towers 108 can also include one or more Radio Frequency Identification Device (RFID) readers 112. RFID readers 112 read RFID tags 104 placed on or inside vehicle 102. In one embodiment, the RFID reader 112 interrogates the RFID tag 104 in the vehicle 102 as is well known in the art. The RFID tag 104 then sends information to the RFID reader 112. This information can include the vehicle identification number of the vehicle 102, the make and model number of the vehicle 102, or any other information important for use in the rental car industry, and the like. In one exemplary embodiment, identification information can be sent to software, such as counter management software running on the rental car computer 120 that can then start the rental car check-in procedures for the vehicle 102. In another embodiment, the images and identification images can be associated with a rental contract upon check-out (renting) of the rental vehicle 102. While towers 108 with RFID readers 112 are depicted in FIG. 1, other methods are possible for communication between the image capture booth 106 and the vehicle 102. For example, vehicle 102 can have bar codes affixed to them which can be read by a bar code reader. In an alternative method, information can be inputted manually while the images are captured automatically.

Rental car computer 120 can be any computer or combination of computers having a processor and a mass storage device that can receive data from the image capture booth 106 via a data connection 109, which can be any wired or wireless data connection, and share the data in a database or equivalent. In one embodiment rental car computer server 120 is a car rental agency computer system that includes counter management software for, among other things, managing a rental car fleet. In one exemplary embodiment, rental car computer server 120 can include one or more networked computers (not pictured) having access to a shared or separate inventory of rental cars. Thus, an individual rental car agent at one location can access data including the images captured at the image capture booth 106 in another location. The agent can then compare new images against older stored images to determine if the vehicle has been damaged. This is especially useful when a car is rented in one location but returned in another.

Remarketer computer 124 can be any computer or computer system operated by a vehicle remarketer, having a processor and storage memory, and configured to store data concerning rental vehicles for sale provided by a rental car company while the rental vehicle is simultaneously available for rental at the rental car agency. In one exemplary embodiment, the remarketer computer 124 receives vehicular information that includes images captured by the image capture booth 106 to facilitate the sale of the vehicle 102. The information regarding specific rental vehicles that can be made available for sale are sent from the rental car computer server 120 to the remarketer computer 124 via a rental vehicle systems counter management software. Alternatively, the remarketer computer 124 can access remotely stored data regarding rental vehicles that are available for sale. Thus, this allows rental car vehicles 102 to be part of a rental car fleet and available for rent while simultaneously available for sale. This maximizes the usage of the vehicle 102 by allowing it to be rented until sold. Also, a potential buyer could rent a car as a way of trying the car out before buying. If the buyer likes the car, credit could be given towards the purchase. Previously, a rental car would have to be taken out of the rental car fleet and placed on a sales lot or sold at auction.

Purchaser computer 126 can be any computer such as a home computer, a computer in a public location such as a computer kiosk, a handheld computer device and the like that can communicate with the remarketer computer 124 to search for rental cars for sale. In one exemplary embodiment, purchaser computer 126 is configured to run a web browser program, such as Internet Explorer by Microsoft, which can exchange information with a website hosted by the remarketer computer 124 using the web browser, the purchaser computer 126 can search an inventory of rental vehicles for sale that are also currently available for rent.

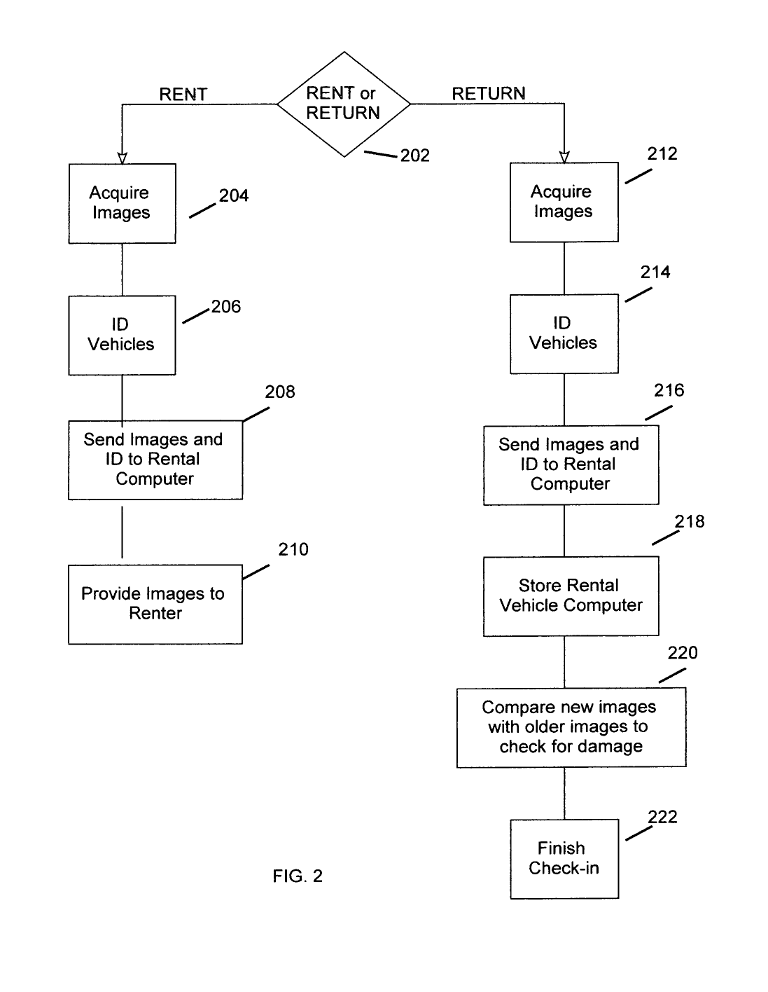

FIG. 2 is a flowchart illustrating an exemplary method for tracking damages in rental vehicles. First, it is determined if the vehicle 102 is being rented or being returned from rental in step 202. In the case of rental, the vehicle renter or other party can drive the vehicle 102 through the image capture booth 106 where multiple images of the vehicle will be acquired. These images can include images of the front passenger and driver side, the rear passenger and driver side, the front of the vehicle and the back of the vehicle. The choice as to the number and location of the images to be acquired can be varied depending on need. This acquisition of images is done in step 204. In an alternative embodiment, the vehicle 102 acquisition step can be performed by the rental car company.

In step 206, identification information concerning the car is gathered. In one embodiment, RFID tag 104 is read by the RFID reader 112. Then, the images and RFID tag 104 information can be sent to rental car computer server 120 or other computers where the images can be associated with the rental contract in step 208. As an option, in step 210, the photographs can be printed and provided to the vehicle 102 renter for his records.

If, in step 202, the vehicle 102 is being returned from rental, the vehicle 102 is again driven through the image capture booth 106 in step 210. In step 212, the vehicle 102 is identified when the RFID reader 112 interrogates and receives a reply from the vehicle's 102 RFID tag 104. This information can then be used to find the rental car contract associated with the returning vehicle, as discussed in greater detail below.

In step 214, various images of the vehicle 102 are captured. In one embodiment, the same or approximately the same parts of the vehicle 102 imaged when renting the vehicle 102 will be imaged when the vehicle 102 is returned.

In step 216, the vehicle identification information and images are sent to a computer, such as rental car computer server 120 as shown in FIG. 1. In step 218, the images are stored on the rental car computer server 120 for a record of damages. In step 220, the images captured upon return of the rental vehicle can be compared to previous images to determine if there is any new damage. In one embodiment, this can be done manually by a rental agent viewing the images from when the vehicle 102 was rented and when the vehicle 102 was returned. In an alternative embodiment, software can be used to analyze the images to determine new damages appearing on the images and classify the type of damage in the image.

In step 222, the vehicle 102 check-in can be completed using the stored data and a receipt can be presented to the renter. In an exemplary embodiment, the information from the vehicle 102 RFID tag can be used to retrieve the rental car contract.

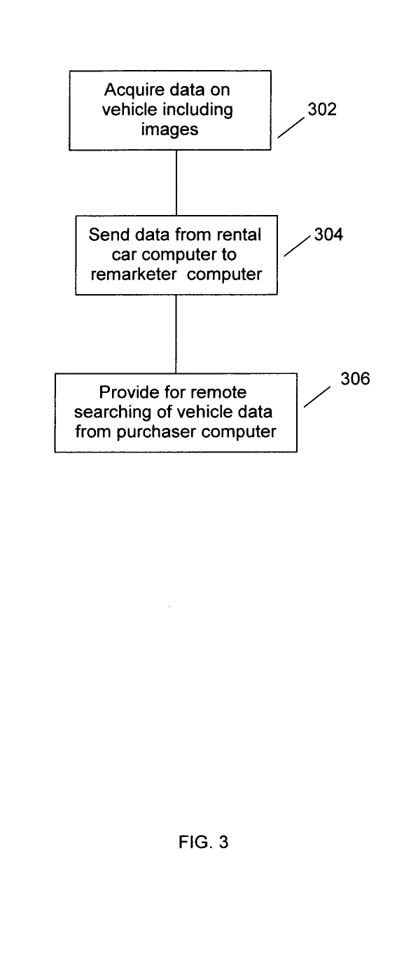

FIG. 3 is a flowchart of an exemplary method to remarket rental vehicles in accordance with the teachings of the present invention. In a first step, step 302, data about the vehicle 102, including the images captured of the vehicle 102 (typically the most recent images will be sent) from the rental car's counter management software to the vehicle remarketer computer 124.

In step 304, the data from the rental car company's counter management software can be stored in a database of the vehicle remarketer computer 124. In step 306, potential car buyers utilizing the purchaser computer 126 can search the remarketer's database for vehicles 102 to purchase. At the same time the vehicles 102 are available for rental in a rental car company, they are also available for sale in a vehicle remarketer database. This allows a rental car company to maximize rental revenue and can lower the resell price of rental cars to consumers. This is discussed in detail in pending patent application Ser. No. 09/885,495 entitled “Selling Assets Over a Computer Network” by Mordechai Kahana, which is hereby incorporated by reference.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A system for tracking damages in a rental vehicle comprising:
an image capture booth configured to capture images of the rental vehicle, the images including an indication of damage to the rental vehicle; and
a rental computer coupled to the image capture booth, the rental computer configured to receive the images of the rental vehicle.

2. The system of claim 1 wherein the image capture booth is further configured to capture identification information, the identification information comprising data concerning the rental vehicle.

3. The system of claim 2 wherein the image capture booth further comprises an RFID reader configured to interrogate an RFID tag on the rental vehicle to retrieve identification information stored on the RFID tag.

4. The system of claim 2 wherein the image capture booth comprises at least two towers spaced apart to allow the rental car vehicle to pass between the two towers.

5. The system of claim 4 wherein a digital camera is mounted on each of the at least two towers, the cameras configured to capture images of the rental vehicle.

6. The system of claim 2 wherein the rental computer is configured to receive the images of the rental vehicle and the identification information upon the renting of the vehicle.

7. The system of claim 2 wherein the rental computer is configured to receive the images of the rental vehicle and the identification information upon return of the rental vehicle.

8. The system of claim 1 wherein the images of the rental vehicle are compared with one or more previous images to determine if there is damage to the rental vehicle.

9. The system of claim 1 further comprising a remarketer computer coupled to the rental computer, the remarketer computer configured to receive the images of the rental vehicle and the identification information and list the rental vehicle as available for sale while the rental vehicle is still part of a rental vehicle fleet.

10. A method for tracking damages to a rental vehicle comprising:
capturing images of the rental vehicle at an image capture booth;
determining the identification of the rental vehicle at the image capture booth; and
sending the captured images and the identification of the vehicle to a rental car computer system.

11. The method of claim 10 further comprising the step of sending data including the captured images to a remarketer computer, the rental vehicle offered for sale while simultaneously available for rent.

12. The method of claim 10 wherein the step of determining the identification of the rental vehicle further comprises the step of interrogating an RFID tag mounted on the vehicle using an RFID reader mounted in the image booth.

13. The method of claim 10 wherein the step of capturing images of the rental vehicle further comprises the step of driving the rental vehicle between two towers, each of the two towers having a digital camera mounted thereon.

14. The method of claim 10 further comprising the step of comparing the captured images of the rental vehicles with one or more previous images to determine if there is damage to the rental vehicle.

15. An image capture booth comprising:
a first camera mounted on a first tower;
a second camera mounted on a second tower; and
a path defined between the first tower and the second tower for the rental vehicle to pass through, the first camera and the second camera configured to capture images of the rental vehicle as it drives down the path.

16. The image capture booth of claim 15 further comprising an RFID reader coupled to the first tower, the RFID reader configured to interrogate an RFID tag mounted on the rental vehicle to determine vehicle identification information.

17. The image capture booth of claim 16 further comprising a rental car computer configured to receive the images of the rental vehicle.

18. The image capture booth of claim 17 wherein the rental car computer is further operable to receive vehicle information and associate the vehicle information and images of the rental vehicle with a rental contract.

19. The image capture booth of claim 18 wherein the images of the rental vehicle are compared with previous images of the rental vehicle stored at the rental car computer to determine if there is damage to the rental vehicle.

20. The image capture booth of claim 17 further comprising a remarketer computer coupled to the rental computer, the remarketer computer configured to receive the images of the rental vehicle and the identification information and list the rental vehicle as available for sale while the rental vehicle is still part of a rental vehicle fleet.
